(19) United States
(12) Patent Application Publication
(10) Pub. No.: US 2015/0170189 A1
(43) Pub. Date: Jun. 18, 2015

(54) SCALABLE, SECURE INCENTIVE CAMPAIGN MANAGEMENT COMPUTER SYSTEM ARCHITECTURE AND METHODS OF OPERATION

(71) Applicants: Carlos I. Santaella, Boston, MA (US); Yuri A. Tijerino, Lindon, UT (US); Justin A. Nguyen, Carlsbad, CA (US); Duc N. Pham, Cupertino, CA (US)

(72) Inventors: Carlos I. Santaella, Boston, MA (US); Yuri A. Tijerino, Lindon, UT (US); Justin A. Nguyen, Carlsbad, CA (US); Duc N. Pham, Cupertino, CA (US)

(21) Appl. No.: 14/132,873

(22) Filed: Dec. 18, 2013

(51) Int. Cl. G06Q 30/02

(52) U.S. Cl. CPC G06Q 30/0229

(57) ABSTRACT

An incentive rewards program that enables an initiating participant entity to dynamically specify incentive rewards point values with respect to defined activities that may be variously performed by other participant entities and by consumers. These entities are nominally associated with vertically aligned business tiers including a retail operator tier. The initiating participant entity is nominally only indirectly associated with retail participant entities associated with the retail operator tier. Retail participant entities record transactions that associate incentive program account identifiers with identified defined activities. These transactions are largely autonomously retrieved, parsed and qualified against the defined activities specified by the initiating participant entity. Corresponding sets of reward points are allocated from an account corresponding to the initiating participant entity to accounts corresponding to the account identifiers recorded in the transaction records.

### BACKGROUND OF THE INVENTION

1. Field of the Invention

The present invention is generally related to incentives-based electronic commerce systems and, in particular, to an incentives-based, electronic commerce management system integrated across multiple supply chain tiers, including manufactures, service providers, merchants, and consumers.

2. Description of the Related Art

Incentive award programs have been developed in a variety of industries to promote customer loyalty. Generally, such programs reward customers for repeat business with the same merchant or service provider by accumulating reward points that can then be redeemed in exchange for some specific goods or services. Typically, these redemptions are constrained to defined offerings by a particular merchant or service provider or to a redemption catalog or other predefined list of goods and services. The value of reward points is typically calculated by the reward program operator using a formula or ratio that relates to the value of qualifying retail purchases, such as monetary significance and volume, among several potentially applicable criteria. Because the actual formula used is often quite complex, and significant factors such as the actual, underlying value of redeemed goods or services may be difficult to determine, if at all, customers are often unable to accurately evaluate the actual benefits offered by different, potentially competitive, customer loyalty programs.

The variety of programs that can be generally referred to as loyalty, incentive, and rewards programs is fairly broad. A common theme is the intension of the program to induce customer loyalty to particular merchants or service providers who directly provide goods or services to the end, or so-called retail, consumer. In other words, these prior art programs operate to enable retail businesses, financial institutions, and others in direct customer contact to provide incentives to their customers to engage and obtain repeat business.

One well-known example of a customer incentive program is the “frequent-flyer” programs used to induce repeat business by airlines passengers. The awarded “mileage points” are based generally on the distances traveled, but are often subject to black-out dates, seating constraints, and other similar limitations. Even subject to these limitations, the customers do receive a measure of real value through redemption of mileage points for free or reduced cost flights. Milage points redemption is often extended to flights with other airlines, car rentals, and hotels based on corporate connections, private, cross-promotion agreements, or other similar commercial arrangements. This horizontal association of providers typifies current rewards programs in that they seek to offer customers a broad engaging range of values that are, nonetheless, constrained to a limited set of merchants and service providers. The value potential of such a rewards program to any given consumer is generally difficult to evaluate by itself or in comparison to any other competing program.

As another example, financial institutions utilize incentive award programs to induce usage of particular financial instruments, such as credit and debit cards. These programs operate by assigning reward points or loosely ‘dollar-equivalent’ value points based upon the monetary value of purchases made using the particular financial instrument. The award points earned can be redeemed for goods or services selected from certain, participating providers. Alternatively, or in addition, customers may be able to convert accumulated reward points to a dollar value that is then applied against their account balance with the financial institution. Such programs often contain limits based variously on what is considered a qualifying purchase, differential point-rates applicable to different purchases, minimum purchases over defined time-limited periods, and, frequently. annual award maximums. Much in the same way as the mileage awards programs, the rewards providers participating in a given financial institution incentive award program are typically those interrelated by corporate affiliations and cross-promotional agreements.

Known rewards programs range in scope from a single merchant, at a single store, offering a buy ten, get one free program, to franchised chains that honor reward redemptions independent of the member store where qualifying purchases were made, to international providers of interlocking products and services that span broadly defined industries, such as travel, entertainment, and food. While relatively rich in their variety, these existing rewards programs are almost entirely employed by public-facing businesses that have direct, retail consumer contact and rely on a level of assured repeat business to provide stability relatively independent of transient economic conditions. Many, perhaps even most, businesses are not public-facing businesses or do not have a significant degree of retail consumer contact. In general, the known rewards programs do not address whatever possible needs or interests of these other businesses. As a result, these other businesses do not have a meaningful opportunity to participate in, let alone, benefit from the commercial benefits afforded by participation in a rewards program.

Consequently, a need exists for system that enables meaningful participation in an incentive, loyalty, or rewards program by businesses independent of whether they are public-facing or have significant retail consumer contact.

### SUMMARY OF THE INVENTION

Thus, a general purpose of the present invention is to provide an efficient and effective system of executing an incentive, loyalty, or rewards program that enables businesses, independent of size or scope, of horizontal and vertical position relative to other participating businesses, or of having existing corporate or contractual associations, to mutually and collaboratively participate in and achieve the commercial benefits of such a rewards program.

This is achieved in the present invention by an incentive rewards program that enables an initiating participant entity to dynamically specify incentive rewards point values with respect to defined activities that may be variously performed by other participant entities and by consumers. These entities are nominally associated with vertically aligned business tiers including a retail operator tier. The initiating participant entity is nominally only indirectly associated with retail participant entities associated with the retail operator tier. Retail participant entities record transactions that associate incentive program account identifiers with identified defined activities. These transactions are largely autonomously retrieved, parsed and qualified against the defined activities specified by the initiating participant entity. Corresponding sets of reward points are allocated from an account corresponding to the initiating participant entity to accounts corresponding to the account identifiers recorded in the transaction records.

An advantage of the present invention is that it enables a wide variety of businesses, including those without direct, retail consumer contact, to efficiently and effectively participate in consumer reward programs that incentivize retail consumers relative to the purchase of specific products and services. Incentive campaigns can be tailored to highlight and encourage loyalty to brands, product manufactures, and service providers relatively independent of the retail or public-facing businesses providing direct customer contact.

Another advantage of the present invention is that it establishes a new, electronic marketplace for top-tier, mid-tier, and retail-tier businesses to interact, establish business relations, and optimize the distribution and sale of products and services to consumers. All participants in this marketplace can choose and support incentive campaigns as initiated by themselves or others and, similar to retail consumers, earn compensatory rewards for providing support for the campaigns initiated by others.

A further advantage of the present invention is that the rewards system is driven by a straightforward identification of the purchase awards available to consumers for any participating product or service. The system identifies the base award corresponding to the campaign commitments made by tier-participants based on the purchase point. A retailer or other redeeming business can increase the value of an award at the time of purchase or of redemption, thus giving the consumer a substantial degree of certainty regarding the value of participating.

Still another advantage of the present invention is that the system enables consumers to remain anonymous relative to the businesses in the participating tiers, including the retail-tier. Qualifying transactions, for purposes of earning reward points, are securely associated through operation of the system as accounts without further consumer identifying information. In addition, various forms of feedback actively handled through operation of the system are securely associable by account numbers giving certainty that the feedback is from an actual purchaser, yet without necessarily revealing consumer identifying information. Different types of feedback can be incentivized, through directed campaign design, to earn different amounts of reward points.

Yet another advantage of the present invention is that the system enables businesses not otherwise able to participate in conventional reward programs to actively engage in the design and execution of incentive campaigns, whether independent of, coextensive with, or in response to incentive campaigns initiated by others. By the selective sharing of campaign related information, participants using the present system have significantly enhanced opportunities to participate in campaigns initiated by other participant businesses, thereby fostering cooperation and greater mutual economies through use of the system.

### BRIEF DESCRIPTION OF THE DRAWINGS

FIG. 1 illustrates a preferred environment for a preferred embodiment of the present invention.

FIG. 2 provides a generalized schematic view of the participant entities and relationships in the channel delivery of goods and services inter-operating with an incentive management system in accordance with a preferred embodiment of the present invention.

FIG. 3 is a block diagram illustrating an incentive management system constructed in accordance with a preferred embodiment of the present invention including communications elements as operationally deployed and used relative to the various tier-providers.

FIGS. 4A-4c illustrate the consumer and retail-tier apparent aspects of participation as implemented in preferred embodiments of the present invention.

FIG. 5 is a block diagram of the primary components of an incentive management system constructed in accordance with a preferred embodiment of the present invention.

FIG. 6 provides a block diagram of a social and directed feedback collection and analysis component of an incentive management system constructed in accordance with a preferred embodiment of the present invention.

FIG. 7 provides a message-oriented flow diagram generally illustrating secure communications transactions involved in the creation and execution of an incentive-enhanced campaign for the marketing of goods and services in accordance with a preferred embodiment of the present invention.

FIG. 8 provides a message-oriented flow diagram demonstrating various activities and transactions, including transfers of money and reward points, between tier participants and consumers in accordance with a preferred embodiment of the present invention.

FIG. 9 is a detailed block diagram of an incentive management system constructed in accordance with a preferred embodiment of the present invention enabling secure, peer communications selectively among participant entities.

FIG. 10 is a block diagram illustrating a preferred virtual appliance providing a virtual device and virtual portal as deployed local to a participant entity and interoperable with an incentive management system constructed in accordance with a preferred embodiment of the present invention.

FIG. 11 provides a general identification of a set of secure communications messages exchangeable among a first class of participant entities in accordance with a preferred embodiment of the present invention.

FIG. 12 depicts a preferred format of a secure, multi-encrypted communications message format exchangeable among a first class of participant entities as implemented in accordance with a preferred embodiment of the present invention.

FIG. 13 provides a general identification of a set of secure communications messages exchangeable among a second class of participant entities in accordance with a preferred embodiment of the present invention.

FIG. 14 depicts a preferred format of a secure, encrypted communications message format exchangeable among a second class of participant entities as implemented in accordance with a preferred embodiment of the present invention.

FIG. 15 is a block diagram detailing an implementation of a campaign core analysis component as constructed in accordance with a preferred embodiment of the present invention.

FIG. 16 provides a message-oriented flow diagram generally illustrating the process of design, analysis, and initiation of an incentive campaign in accordance with a preferred embodiment of the present invention.

The presently preferred embodiments of the present invention will be described within the natural scope of the local, national, and international economies and business practices to which the present invention relates. As is well recognized, a variety of terms can often refer to the same concept or practice. Conversely, a given term, phrase, or even acronym may be used in different contexts, even if only slightly different, to quite different concepts and practices. Accordingly, the following description should be read with appropriate allowance for terms defined by common usage, further considered with respect to this specification as a whole and the accompanying figures, where like reference numerals are used to designate like parts depicted in one ore more of the figures.

In general terms, most products and services offered for sale for consumption by the purchaser, as opposed to resale, are nominally denoted as retail products. These products and services are sold to a consumer who, as a general member of the public, makes the purchase through a business nominally denoted as a retail store or similarly identified establishment. Retail products, often beginning with raw materials, are constructed of parts that are assembled, packaged, labeled, warehoused, advertised, distributed, promoted, displayed and eventually sold, in some manner, to a consumer. Such supply chains range from the simple to quite complex depending on the nature and type of intermediary and final consumer products and the various business entities that implement or execute different supply chain operations. Often, a supply chain is described as starting with a manufacturer of a some product, with various supplementary supply chains providing the manufacturer with materials, parts, and services, and with distribution supply chains that, in general, provide for the transfer of products to retail marketplaces.

Most business entities currently implement some form of computerization or electronic technology in order to plan for and manage materials, parts and products moving through their portion of often many different specific supply chains. This is particularly true of businesses that participate in the retail tier of the supply chains. Such business typically offer for sale a wide variety of products in their day-to-day operations purchased directly from various available supply chains. Retail stores will often have little or no direct contact, association, or interaction with the original manufacturer of a product. Similarly, the various intermediary businesses involved in supply chains will often have only direct interactions with the businesses in the next higher product distribution tier.

The electronic technologies used most often take the form of an inventory control and tracking system. As exemplary for retail businesses, the technology is realized as a point-of-sale (POS) inventory management system that automates or assists in the execution of checkout transactions, tracking goods currently available or in transit, and other similar operations. POS systems typically employ automated check-out terminals that are capable of reading or sensing product identification information typically applied as a label or tag on each product by the original manufacturer or other business entity participating in the supply chain. The product identification typically takes the form of, for example, a Universal Product Code (UPC), for goods manufactured or intended for sale in the US and Canada, a European Article Number (EAN), for goods registered, manufactured, or intended for sale in Europe and several other countries. The product identifier may be sensed from an electronic tag embedded in or attached to the product, printed on the product as a bar code, or a human readable number printed on the product packaging. Multiple forms are often employed simultaneously on any given product.

Typically, the product manufacturer assigns and applies a UPC to each product sold or delivered into the supply chain. UPC and similar identifiers encode a universally unique identification of a business entity, typically the product manufacturer, and the a product number chosen internally by the manufacturer to identify the product type. As standardized, UPC and similar codes are insufficient to uniquely identify a particular instance of a product. Each business entity participating in a supply chain will typically also assign an internally chosen identification number to a product in whatever form it may take, such as individually packaged products, cases of products, or pallets of such cases, as handled by the particular business entity. Retailers typically assign an internally chosen Stock Keeping Unit (SKU) number or code that is recorded in an inventory database with other information to identify the specific item or style of merchandise.

A retail POS terminal typically enables entry of the UPC code and SKU using an electronic scanner or barcode reader. This information is sufficient to enable inventory management of the individual products by the retail establishment. Since the products sold at retail were purchased from the supply chain, the original manufacture receives little, if any, information regarding the purchase transactions, the consumers who made the purchases, or the reasons that any particular consumer chose to purchase a product produced by a particular manufacturer or a competitor. At best, a manufacturer will get aggregated information regarding overall sales and some indication of inventory levels at different locations in the supply chain. The only practical exception is where the manufacturer is vertically integrated and thus owns the entire supply chain to and including the retail outlets. For non-vertically integrated manufacturers and the various business entities in the tiers constituting the supply chain, the SKUs that might be retrievable from lower tiers are essentially meaningless. Without intimate access and understanding of the lower-tier database that records a particular SKU, their SKU is an unidentifiable number. Moreover, most business entities will readily provide detailed sales data, since doing so could be advantageous to a competitor.

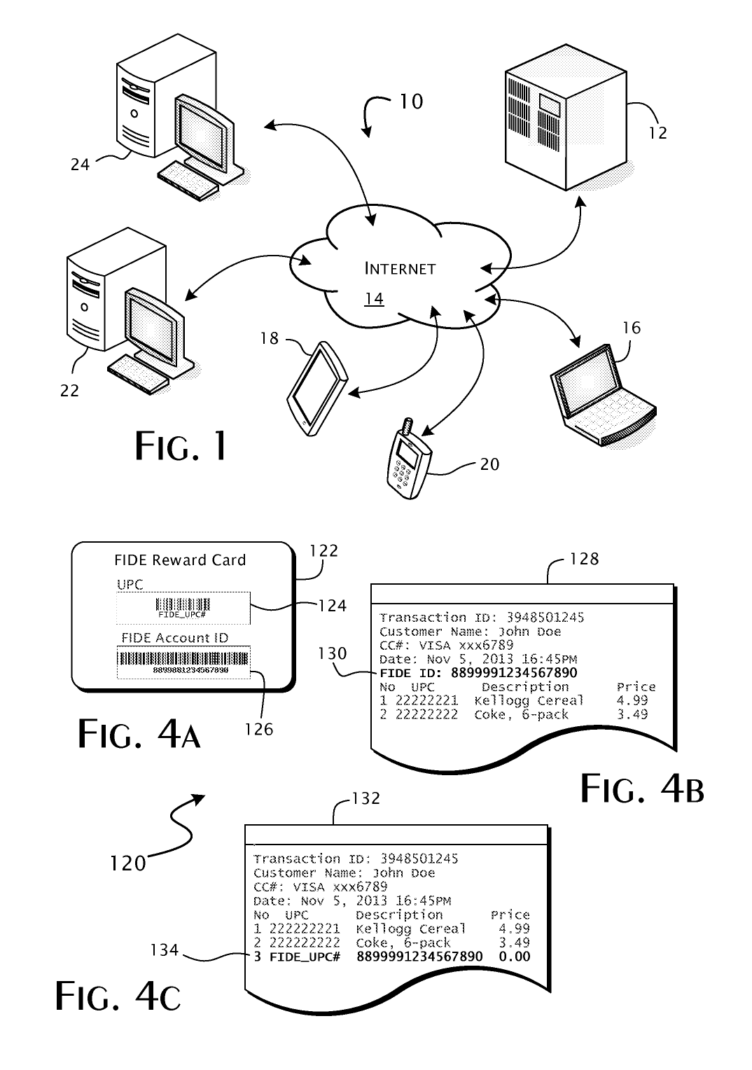

Referring to FIG. 1, a preferred execution environment 10 includes a conventional Web server system 12 that operates as a host for the Web sites and related application as implemented in the preferred embodiments. The Web server system 12 may be implemented as a conventional, local Web server and Web service capable computer server system, hosted in remotely managed, geographically distributed dedicated computer service centers, or functionally virtualized and executed anywhere within a distributed computer system operated by a software as a service (SaaS), platform as a service (PAAS), or infrastructure as a service (IaaS).

The Web sites and services are generally accessible through a public network, such as the Internet 14, allowing end users, including business entities and consumers, to access with the Web site. These users may use various client devices, such as personal and notebook computers 16, tablets and smart phones 18, 20, and other similar computer devices. Business entities will typically access the Web server 12 using networked computer systems 22 that include both conventional personal computers and workstations and various proprietary computing devices typically as specialized for inventory control and management.

Operational management of the incentive rewards programs is preferably performed by system operators accessing the server 12 using personal computers and workstations 24 connecting directly to the server 12 or through a secure Web management dashboard nominally accessible via the Internet 14.

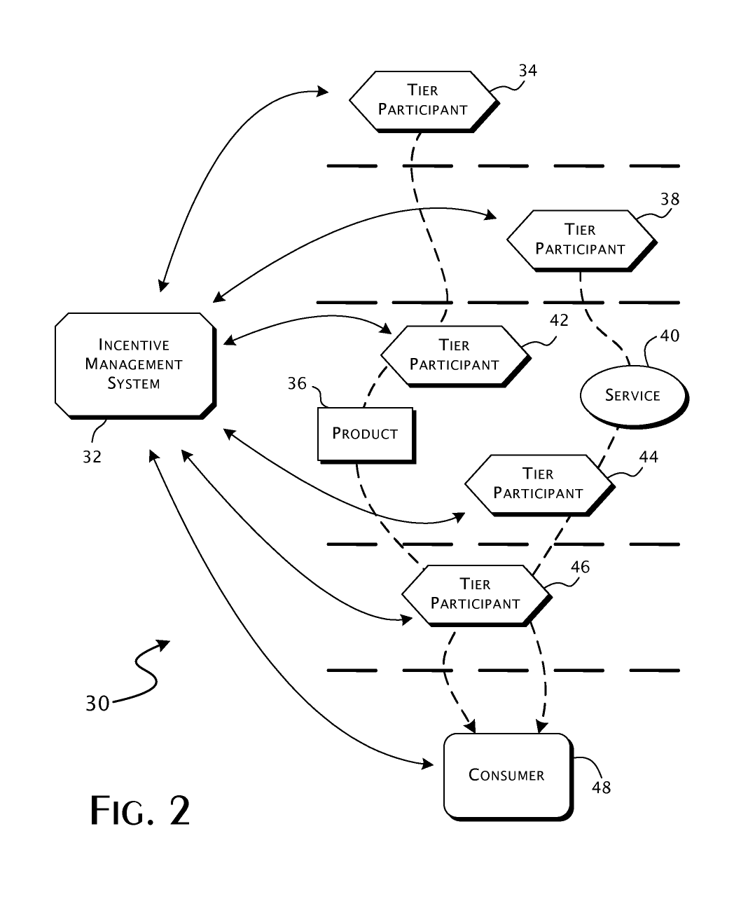

As generally represented in FIG. 2, the Web sites and services implemented in the preferred embodiments are available to business entities participating at any level or tier in the supply chains 30 that exist in the local, national, and international economies. The incentive management system 32 is accessible by top level tier participants 34, typically manufacturers of products 36. Other upper level tier participants 38 may provide services 40. As is conventional, mid-tier participants 42, 44 function variously as distributors and value-added resellers of the products and services 36, 40 moved through the supply chain. The products and services 36, 40 eventually reach lower-level tier participants 46 operating generally as retailers of often a wide variety of products and services 36, 40 originally manufactured and provided by many different upper level tier participants 34, 38, including those that are re-branded or specialized by mid-tier participants 42, 44.

For purposes of the present invention, the designation of different business entities as participating at particular tiers is intended to be flexible, recognizing that business entities that offer or handle multiple products and services will often act as tier participants at different levels within the same or different supply chains, depending specifically on the nature and interests of the business entities. In particular, in the retail tier, business entities will be particularly varied with respect to the type and variety of products and services presented for consumer sale, as well as the level of sophistication and specialization of their targeted consumers demographics. In general, retail business entities, and the retail tier, are characterized as resellers of products and services to consumers 48 who are, in turn, defined as the end-users who effectively consume the products and services.

As will be discussed in further detail below, the incentive management system 32 enables the various tier participants 34, 38, 42, 44, 46 to interact and electively co-operate with the objective of creating and executing targeted incentive rewards programs that will directly incentivize consumers in targeted demographics to preferentially select and purchase targeted products and services. The incentive management system 32 thus operates in the general capacities as an information distributor, electronic marketplace, and clearing house enabling distant or otherwise only indirectly related business entities to initiate and participate in targeted product and service promotion campaigns.

Consumers 48 occupy a tier in the supply chain typically referred to as the end, terminal, or simply the consumer tier of the supply chain. The consumers 48 are also able to interact with the incentive management system 32, though provided with a view generally of the electronic marketplace that is distinct from that available to the various business entities participating from the higher level tiers of the supply chain. As will be discussed in further detail below, the inventive management system 32 selectively provides consumers with a view to the demographically appropriate incentive campaigns currently running and, optionally, to campaigns planned but not yet started. Preferably, the consumer view allows consumers 32 to search in various ways, such as by product or service name or by category, to identify a specific product or service that is currently being promoted, the value of the promotion, and locations of retailers where purchases of the identified product or service can be made.

A preferred implementation 60 of the incentive management system 32 is shown in FIG. 3 in association with illustrative systems utilized by participant business entities 34, 38, 42, 44, 46 and consumers 48. As shown, consumers 48, can communicate with the incentive management system 32 using a personal computing device 18 executing a conventional client Web browser application or a specialized application 62 generally as provided by the system operators of the incentive management system 32. In a preferred embodiment of the present invention, the specialized application 62 executes on the device 18 as an adjunct to the native client Web browser to streamline security handling and to customize other aspects of interactions with the incentive management system 32.

Messages, preferably using the conventional HTTPS protocol as the underlying transport mechanism, are exchanged between the device 18 and a system portal processor 64 via the Internet 14 and conventional Web server application program interface (API) provided by the implementation of the incentive management system 32. The system portal processor preferably recognizes communications sessions with consumers 32 to provide access to a hosted consumer Web site representing the consumer appropriate view of pending and running incentive campaigns. Data for the consumer Web site is provided by an incentive management processor that actively handles the activities and processes used in implementing incentive campaigns. Account, transactional and other data developed for or as a product of incentive campaigns is stored by a data store 70. Security related data, including for example, account passwords and security certificate keys used in controlling access to and enabling use of the incentive management system 32, are maintained in a key store 72. Both the data store 70 and key store 72 may leverage distributive technologies. The data store 70 may be realized using distributed storage area networks (SANs) and similar network-based storage systems. The key store 72 may leverage use of the Lightweight Directory Access Protocol (LDAP), the Kerberos protocol, and others similar technologies to access distributed secure servers to store and access security related data.

Alternately, though typically in addition, consumers 48 can utilize conventional personal and notebook computers to access the system portal processor 64 using any of the conventional, industry-standard client Web browsers 80. The consumer Web site hosted by the system portal processor 64 may be realized using conventional HTML5 compliant Web pages. Preferably, page requests directed to the consumer Web site retrieve, in addition, a client-side Web application 82 that executes within a secure context of the client Web browser 80. The client-side Web application 82 preferably integrates 84 with the retrieved Web pages of the consumer Web site to assist in the discovery and selection of products and services as may be of interest to a particular consumer 48, to evaluate the relative promotional campaign value of different products and services, preferably also relative to possibly competitive products and services uninvolved in a promotional campaign, and in locating suitable locations for the retail purchase of promoted products and services.

The client-side Web application 82 can and preferably also executes to simplify additional consumer 48 activities, such as accessing social media regarding campaign promoted products and services, providing general public information regarding the selection and consumption of such products and services, and providing feedback, including questions, regarding such products and services directed to the manufacturer or supplier of the products and services. Functional implementation of these services is preferably split between the client-side Web browser executed application 82 and server-side Web applications executed by the system portal processor 64 within appropriate session contexts relative to the consumers 48. Data in support of these services is preferably retrieved from the incentive management processor 68, subject to constraints defined against consumer accounts as a category and for individual consumer accounts referenced by applicable session contexts.

The services enabled by the inter-operation of the client-side Web browser executed application 82 and server-side Web applications executed by the system portal processor 64 are also preferably supported through either standards-compliant operation of the native client-side Web browser provided by the device 18 or through the specialization of the local device application 62, or both. The local device application 62 may be stored local to the device 18 as an updatable, persistent program. Alternately, or in addition, the local device application 62 may be dynamically downloaded in part as needed in combination with a Web page retrieved from the consumer Web site.

A business entity registered with the incentive management system 32 and operating within a supply chain generally at any level above the consumer tier can be referred to as a tier X participant 90. Similar to consumers 48, a tier X participant 90 can interact with the incentive management system 32 via a personal computer, workstation, or other device capable of executing an industry standard client Web browser 80 and personal computing device 18. Access to the incentive management system 32 is typically through the Internet 14 to the system portal processor 64. A distinct tier X participant Web address, business entity account identifier or similar identification data is preferably recognized by the system portal processor 64 to enable access to and interaction with a tier X participant Web site hosted by the system portal processor 64 and supported by operation of the incentive management processor 68.

A local portal application 92 is provided in a preferred embodiment of the present invention to enable secure, distributed access to data that may be provided as part of a streaming or dynamically updated service. A local portal application 92 can be deployed to and locally executed on a computer system that also hosts the Web browser 80. Alternately, a local portal application 92 may be hosted on a client server system, accessible via an Internet connection 94, that allows multiple users within a given business entity to establish separate sessions for interacting with the incentive management system 32.

Use of services enabled through a local portal application 92 can often bypass much of the repeated Web page refresh operation typically required to obtain data updates from the system portal processor 64. Instead, the service data feed is dynamically updated to a current Web page typically as rendered by the client Web browser 80. This enables a reduced loading of the incentive management system 32 and a more responsive presentation of data to the tier X participants 90. These data services are preferably implemented using conventional Web services protocols accessible through the API 66. Alternately, or in addition, conventional and proprietary protocols may be used to access data made available directly by the incentive management processor 68 through an appropriately corresponding API 96. Local portal applications 92 are preferably distributed and maintained under the control and supervision of the system operators of the incentive management system 32.

Tier X participants 90 will typically employ some tier X host application 98 that is involved in inventory control and management of inventory related functions. This application will typically receive accounting inputs reflecting the receipt into inventory of products and services and the distribution of products and services from inventory to other tier participants, including as appropriate consumers 48. A variety of input terminal devices 100 may be employed, including, as representative, card scanners 102, barcode and QR code readers, electronic tag sensors, and manual entry keyboards 104.

In preferred embodiments of the present invention, tier X participants 90 can themselves participate in a manner similar to consumers 48 to earn incentive awards made available to them by the design of an incentive campaign. Transactions relating to the receipt and subsequent distribution of products and services will be processed by their corresponding tier X host application 98. Reports of potentially qualifying transactions are preferably made from the tier X host application 98 to the incentive management system 32 either in a near-real time manner or batched together and transmitted periodically, in response to a manual procedure carried out by a tier X participant 90, on a programmatically fixed schedule, or in response to a polling or similar request operation initiated by the incentive management processor 68.

Transaction reports may be forwarded via the client Web browser 80, potentially with support provided by the client-side Web browser application 82. Transaction reports may also be sent as part of a data update stream through the local portal application 92. A virtual appliance 106 may also be employed to gather the transaction information from the tier X host application 98 for forwarding. As implemented in preferred embodiments of the present invention, a virtual appliance 106 is realized as a software or hardware-based emulation of a data processing device of a type recognized by the corresponding tier X host application 98. As a recognizable device, the tier X host application can be readily configured to transfer information to the virtual appliance 106, specifically including, if not specifically limited, to the transaction report data appropriate for reporting to the incentive management system 32. When data is received by the virtual appliance 106, the data will typically have a well-defined structure that, while perhaps unique to a particular tier X host application, can be parsed to a transaction report record form that can be suitably imported by the incentive management processor 68. Utilization of the virtual appliance 106 substantially reduces the complexity and level of integration otherwise required for substantive communication of transaction records from the many different tier X host applications 98 to the incentive management processor 68. The internal operation and related management of the virtual appliance 106, including security over the transaction report records produced by the virtual appliances 106, is preferably performed by the incentive management system 32 system operators.

In the course of processing transaction reports, the incentive management processor 68 will generate reward settlement records that specify the award of incentive points from one account to another. Reward settlement records can also specify the redemption of points for cash or trade having a cash-equivalent value. The initiator of an incentive reward campaign will have established an incentive points account containing points representing a cash-equivalent value. The incentive points account is preferably maintained internal to the incentive management system 32 and managed by the incentive management processor 68. A separate cash account, having a balance generally equal to the cash-equivalent value, is preferably established with an external financial management institution. Each of the business entities and consumers 48 will have an incentive points account also preferably maintained internal to the incentive management system 32.

Based on the transaction reports processed, the reward settlement records reflect the corresponding transfers of reward points between the various incentive points accounts. To reflect redemptions of points, whether for cash directly or in exchange for some corresponding measure of trade at the point of redemption, appropriate reward settlement records will be transmitted to the financial management institution. These reward settlement records are preferably transmitted by the incentive management processor 68 via a suitable banking industry system API 108 and network 110. Depending on how the settlement is to be performed, the transmitted settlement order will provide instructions for the transfer of a monetary value between some set of external cash accounts representing the parties involved in the redemption exchange.

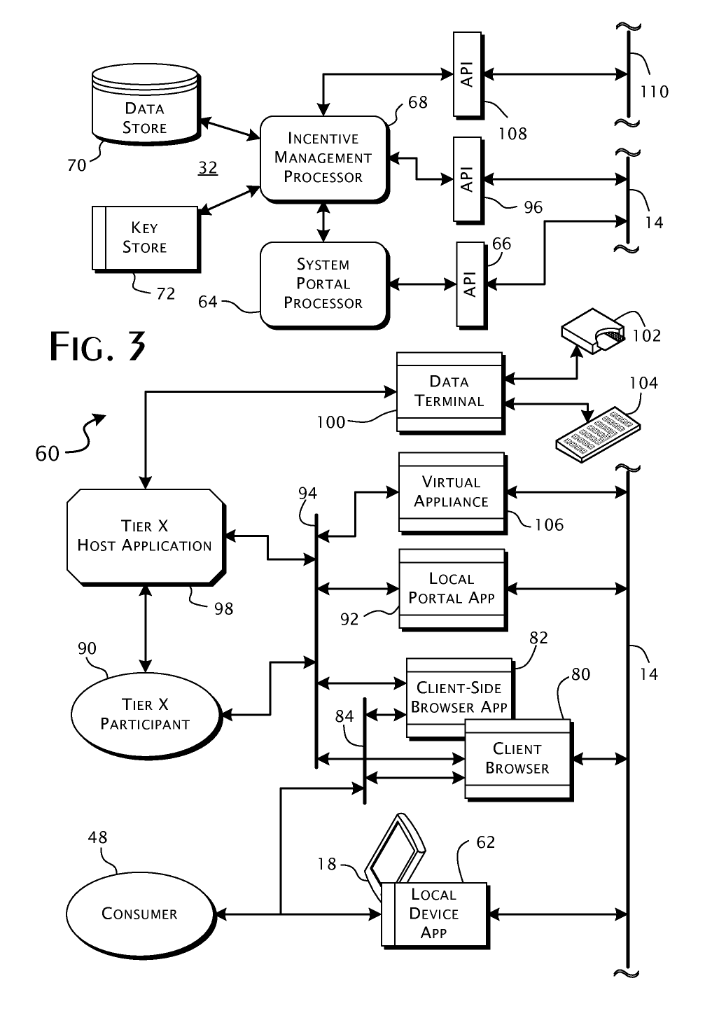

In preferred embodiments of the present invention the incentive points accounts are identified by account numbers unique within the incentive management system 32. Particularly with respect to the consumers 68, though available to all business entities that are participants in the incentive management system 32, a debit-style rewards card is issued with the applicable account number, generally as shown in FIG. 4A. The rewards card 122 is provided with a UPC identifier 124 and an account identifier 126. Both are preferably provided on the card in multiple forms for purposes of convenience. As shown, the UPC 124 and account identifier 126 are preferably printed as bar-codes and human readable alphanumeric equivalents. In addition, the UPC and account number may be encoded in a magnetic strip present on the card 122 or embedded in an electromagnetically readable smart-card chip. Alternately, or in addition, the rewards card 122 can be implemented as a digital equivalent stored in a smart-phone or equivalent device 18.

In the preferred embodiments of the present invention, the account identifier represents the primary information source of data to be used in identifying potentially qualified rewards transactions. The account identifier 126 preferably encodes, utilizing the ISO/IEC 7812 standard, an Issuer Identification Number (IIN) specifying the issuer of the card 122, typically the apparent owner and operator of the incentive management system 32, and an account number. In the initially preferred embodiment, a single IIN is used to identify the actual owner and operator of the incentive management system 32. In other preferred embodiments, apparent owners may be licensed to promote the incentive management system 32 under their own name and with their own IIN. In these embodiments, the original owner and operator will continue as the actual operator of the incentive management system 32 on behalf of the licensees. The account number preferably provides a unique reference to the internal account number of the card-holder. Alternately, the account number encoded on the card 122 is the internal account number.

In the presently preferred embodiments of the present invention, the account identifier 126 is read by terminal equipment 100, 102, 104 and recognized by the tier X host application 98 as, at a minimum, an alphanumeric string to be recorded against a current transaction. As generally shown in FIG. 4B, a transaction record 128 as captured by the tier X host application 98 includes the account identifier 126 as a description string 130. When subsequently reported, description string 130 will naturally be included. These embodiments require the tier X host application 98 to be aware rewards type cards and to include the full ISO/IEC 7812 account identifier 126 in the transaction record also sufficiently identifying the purchased products and services for use in correlating the transaction with a running incentive campaign.

Where the tier X host application 98 has not been updated sufficiently to handle the ISO/IEC 7812 account identifier 126 as discussed above, the UPC 124 can be used as a proxy for a product, allowing entry of the ISO/IEC 7812 account identifier 126 as the description of the proxies product. As generally represented in FIG. 4C, a captured transaction record 132 lists a line item product 134 is defined by the UPC 124. The account identifier 124 is included literally as the product description. To enable this system of capturing the account identifier 124, the only required modification to the tier X host application 98 is the addition of an inventory product record having the UPC 124 as the product identifier. Depending on the capabilities of the terminal equipment 100, 102, 104, the account identifier 124 can be scanned in or manually entered as the detailed description of the product.

A functional block diagram of a preferred incentive management system 140 is shown in FIG. 5. A consumer portal component 142 is executed to provide consumers 144 with a consumer-oriented portal Web site view of the incentive management system 140. A tier X participant portal component 146 similarly provides tier X participants 148 with a participants view of the incentive management system 140. An incentive campaign monitoring component 150 is executed to autonomously monitor for events of specific relevance to the development, evaluation, and execution of promotional campaigns. The monitored events include, in general, messages from tier X participants identifying transaction reports that are available for retrieval and import, messages for relay between tier X participants regarding planned or ongoing promotion campaigns, feedback and product or service inquiries provided typically by consumers 144, and various social media directed communications, again typically sourced by consumers 144, that relate to planned or ongoing promotion campaigns.

An incentive campaign creation component 154 preferably executes on demand by tier X participants 148, accessing via the tier X participant portal component 146, who wish to evaluate the merits of various campaign scenarios and to design and initiate a promotional campaign. In operation, a design element is presented to the accessing tier X participant 148 allowing selection or specification of campaign relevant parameters, such as products involved, geographic region targeted, monetary size of the incentive points account, the allocation of points to be awarded for particular actions taken by consumers 144, and potentially other tier X participants 148, the time-frames involved, and the constraints on the particular distribution channels targeted.

Once a combination of parameters has been selected, the tier X participant 148 can initiate a scenario evaluation where the proposed parameter defined campaign is evaluated by a core analysis component 156. In the presently preferred embodiments, the core analysis component 156 implements a supervised machine learning system that has been trained on the performance of prior executed campaigns. The core analysis component 156 thus provides a reasoned projection of the performance of the parameter designed scenario. The design element can also be used to evaluate modifications of incentive campaigns proposed by other tier X participants 148, and to evaluate the progress and current success of in-progress campaigns. In the former instance, other tier X participants 148 can evaluate whether to actively participate in a proposed incentive campaign by testing whether a modification of the campaign, such as providing additional points for certain activities or for purchases under certain circumstances, will be beneficial to them. In the later instance, tier X participants 148 can compare projections against actual performance as well as refine applicable projections based on current progress in the campaign. For all of the circumstances, the operation of the design element in execution of the campaign creation component 154 provides direct and specific benefits to tier X participants 148.

Finally, a core management component 158 is executed to monitor and administer the incentive management system 140 by system operators 160. In the preferred embodiments of the present invention, the primary operations of the portal components 142, 146, the monitoring component 152 and campaign creation and analysis components 154, 156 run without significant input or adjustment by the system operators 160. In general, the most significant activities of the system operators 160 include ensuring the timely collection and correct parsing of transaction records, supervision of the progressive training of the machine learning system implemented in the core analysis component 156, and providing assistance and training to consumers 144 and tier participants 148 in relation to the correct and optimal use of the incentive management system 140.

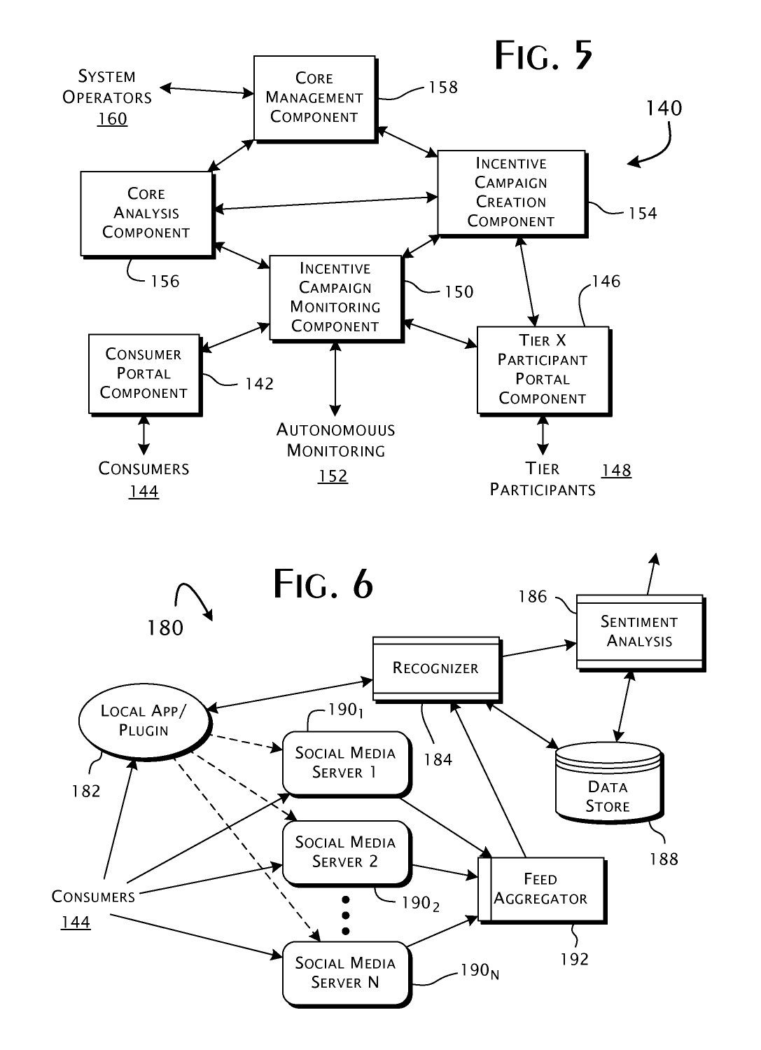

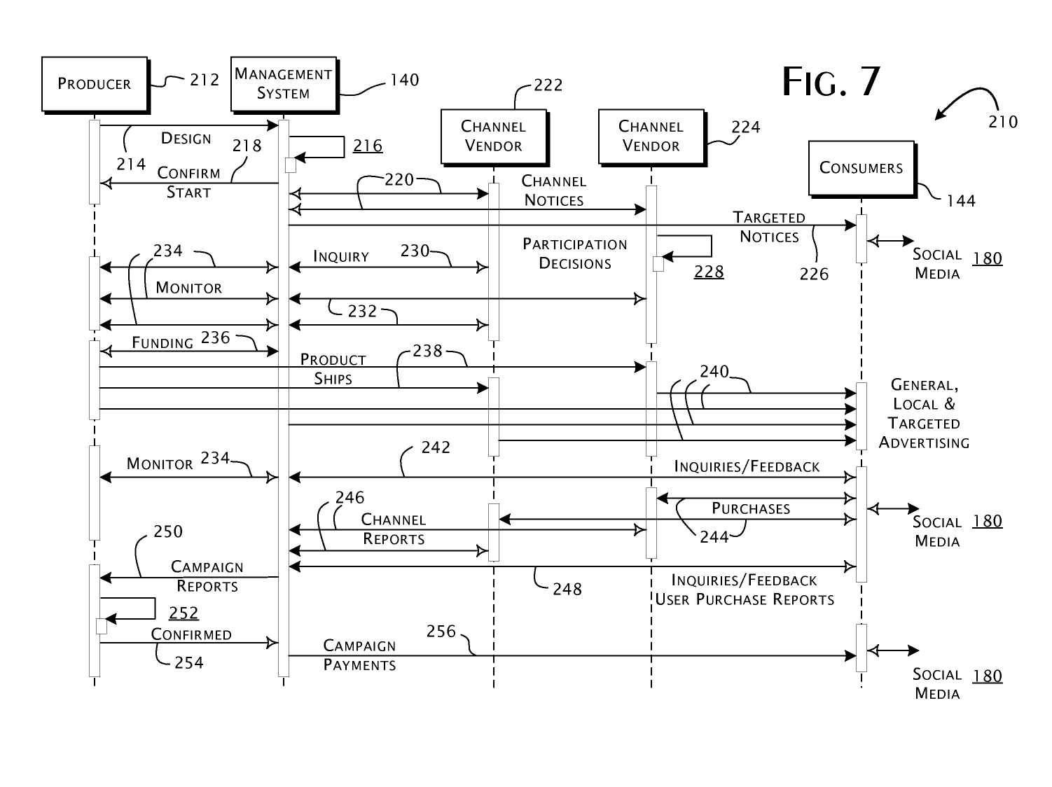

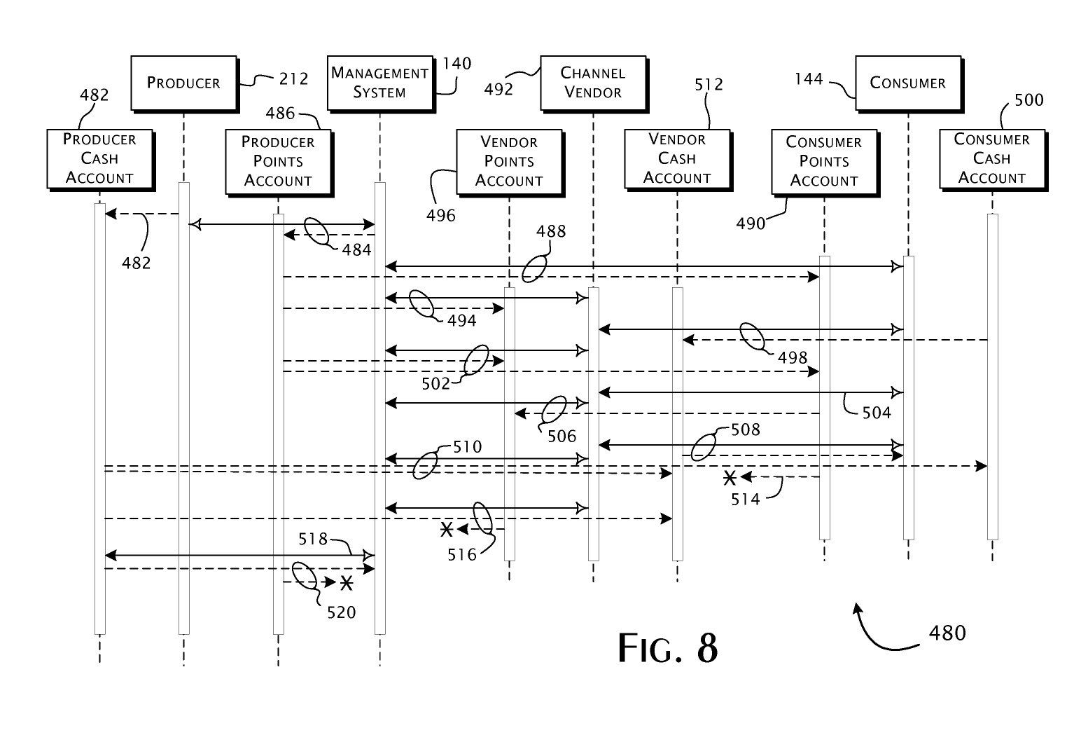

A particularly significant set of activities by consumers 144 that can be encouraged involve social and related public media contributions. Incentivizing consumers 144 to speak positively about product expectations, of experiences in using products recently purchased, and who make the effort to inquire about specific features and functions of products tends strongly to improve consumer selectivity in purchasing and repeat purchasing. In the preferred embodiments of the present invention, a social media monitoring system 180, as shown in FIG. 6, is preferably implemented as part of the incentive campaign monitoring component 150. Consumers 144, who intend to source social or other public media content specifically to have these activities recognized for purposes of gaining additional reward points, can initiate or provide a reference to a social or other public posting by using a consumer specialized application or client Web browser application 182 provided directly or indirectly by the incentive management system 140. The application 182 can preferably be used to forward social media content to a recognizer 184 that executes to identify the incentive points account of the consumer who generated content and the public outlet of the content. Specifically, for social media activities such as adding a “like” or tweeting a short comment about a campaign product or service, the application 182 can provide sufficient information to the recognizer 184 to identify the user and their incentive points account as well as the outlet of the content for purposes of gauging any applicable points award. For a blog post that mentions a campaign product or service or a more lengthy review posting of the product or service, the application 182 can provide the recognizer 184 with the account identity and a URL to the positing for use in evaluating the points value of the activity.

In preferred embodiments of the present invention, consumers 144 and tier participants 148 can establish corresponding member profiles to contain information supporting, directly or indirectly, operation of the recognizer 184. Member profiles are preferably stored in the data store 70. A profile can store social media and related information directly or by reference to a corresponding access API as made available for such purposes by the various social media services. In effect, a profile will preferably identify the social media handles and equivalent user identifiers that can be used to distinguish posts or other authorships of social media content relative to corresponding social media services. The profile can also be used to store author identifiers relative to Web addresses of blogs and similar sources of published content made available for public review and comment.

In a preferred embodiment of the present invention, the recognizer 184 passes the social media or other public content to a sentiment analysis processor 186. Supported by a data store 188 containing a variety of keyword lists, the sentiment analysis processor 186 preferably implements a lexical parser and associative concept identifier to, in effect, judge whether the posting portrays campaign related products and services in a fair and positive light to serve as a threshold basis for determining whether the posting qualifies for a points award.

The application 182 may be used by a consumer 144 as a local proxy for posting to social media servers 190₁₋ₙ. Alternately, consumers may post directly to the social media servers 190₁₋ₙ. A social medial feed aggregator 192 is preferably implemented as part of the campaign monitoring component 150. After duplicate removal and appropriate filtering of extraneous content, the feed output is provided to the recognizer 184. Identification of the content source is preferably based on a self identification of social content names included as part of a consumer profile stored by the data store 70. For social media posts that can be correlated to an identified consumer 144, the content is subjected to sentiment analysis 186 to form a threshold determination of whether points are to be awarded to the indirectly identified incentive points accounts.

Preferably, a history of reward point grants, including both inbound and outbound transfers, is stored in the data store 70 for each consumer 144 and tier participant 148 account and profile. In addition, related information, such as number of points granted, the recognized activity, and names of the purchased or sold products and services, are recorded for each reward points grant, enabling review by account corresponding consumers 144 and tier participants 148. Preferably, any entry of a product or service purchased can be used by a consumer 144 or tier participant 148 to initiate a social media or other public published comment or discussion of the product or service purchased.

An exemplary process flow 210 illustrating the operation of a preferred embodiment of the present invention is presented in FIG. 7. A producer 212 of a product, corresponding to a tier X participant, initially accesses the incentive management system 140 to evaluate the design 214 of an incentive campaign. The design parameters are adjusted 216 utilizing feedback provided through the design element of the incentive management system 140. Once the producer 212 is satisfied with the design, a start date is confirmed 218. The pending campaign is then published 220 such that supply channel vendors 222, 224, who are other tier X participants, can review and consider whether to actively participate in the pending campaign. In addition, a targeted notice may be sent to selected consumers 144 to begin engaging the larger community of consumers 144 through social media 180. The consumers 144 who receive these early targeted notices are selected based on, for example, the size of their connections, friends, or followers who are in a targeted demographic. As shown, the vendor 222 requests additional information 230 via a message posted through the incentive management system 140. Meanwhile, the vendor 224 evaluates the opportunity to actively participate 228 based on some combination of their knowledge and experience in the relevant supply chain and experimenting with different parameterized scenarios using the incentive campaign creation component 154.

The vendors 222, 224 commit to participation 232 in the campaign. The commitment may be either active or passive. With an active commitment, a vendor 222 chooses to contribute to the pool of award points based on the same or different awards criteria than as originally specified for the campaign. In this manner, the vendor 222 can optimize, in part, the value of the points contribution to activities most favorable to creating and repeating business transactions involving vendor 222. Conversely, by committing to passive participation, the vendor 224 provides no additional resources to the campaign. Vendor 224 thus provides no definite commitment to receive or distribute the product that is being promoted by the producer 212. Through the incentive management system 140, the producer 212 can monitor 234 the messages presenting inquiries 230 and providing commitment decisions 232. The producer 212 can respond to and engage the vendors 222, 224 in discussions relative to decisions to be either active or passive participants.

Except where the producer 212 decides to cancel a campaign, such as may be due to a lack of interest among a target demographic based on social media 180 messaging, or among vendors 222, 224, the producer funds the 236 the external cash account and the incentive management system 140 credits a corresponding number of points to the awards account of the producer 212. Initial product shipments then occur 238 generally concurrent with any applicable targeted advertising 240 that the producer 212 and vendors 222, 224 may choose to do as a supplement to the incentive campaign.

General inquiries in advance of products reaching the retail tier and questions after products are available to consumers 144 are passed through the incentive management system 140 to the producer 212. The producer 212 monitors and responds to the inquiries and questions. Generally at the same time, purchases 244 are made by consumers 144, directly or through additional tier levels, of products distributed via the vendors 222, 224. Transaction reports 246 are supplied in near-real time or batched and transmitted to the incentive management system 140. As transaction records are processed, reward points are transferred, as appropriate, from the reward point accounts of the producer 212 and actively participating vendor 222. Throughout this period, consumers 144 continue to mention the relevant products and incentive campaign in social media, as well as mentions in blog posts and, as applicable, provide first hand and technical reviews of the product 180. These activities are evaluated and award points, at rates defined by the design of the incentive campaign, are transferred to the appropriate consumer 144 reward points accounts. Further inquiries, feedback and questions 248 regarding the crediting of reward points are presented to the incentive campaign system 140. These activities are also evaluated and award points transferred to the appropriate consumer 144 reward points accounts. The producer 212, system operators 160, and, if applicable, the vendors 222, 224 respond to consumers 144 in furtherance of the campaign. Also depending on the design of the incentive campaign, transactions directly involving the vendors 222, 224 may qualify as activities that will result in the awarding of points. If there are qualified transactions, corresponding numbers of award points are transferred to the appropriate business entity reward points accounts.

Campaign reports 250 are periodically made available to the producer 212. These reports provide sufficient detail of the qualifying transactions to enable the producer to verify 252 proper execution of the incentive campaign for the included time periods. When confirmed 254, campaign payments 256 from the external cash account are directed as appropriate to the cash accounts of the consumers 144 when corresponding reward points are redeemed.

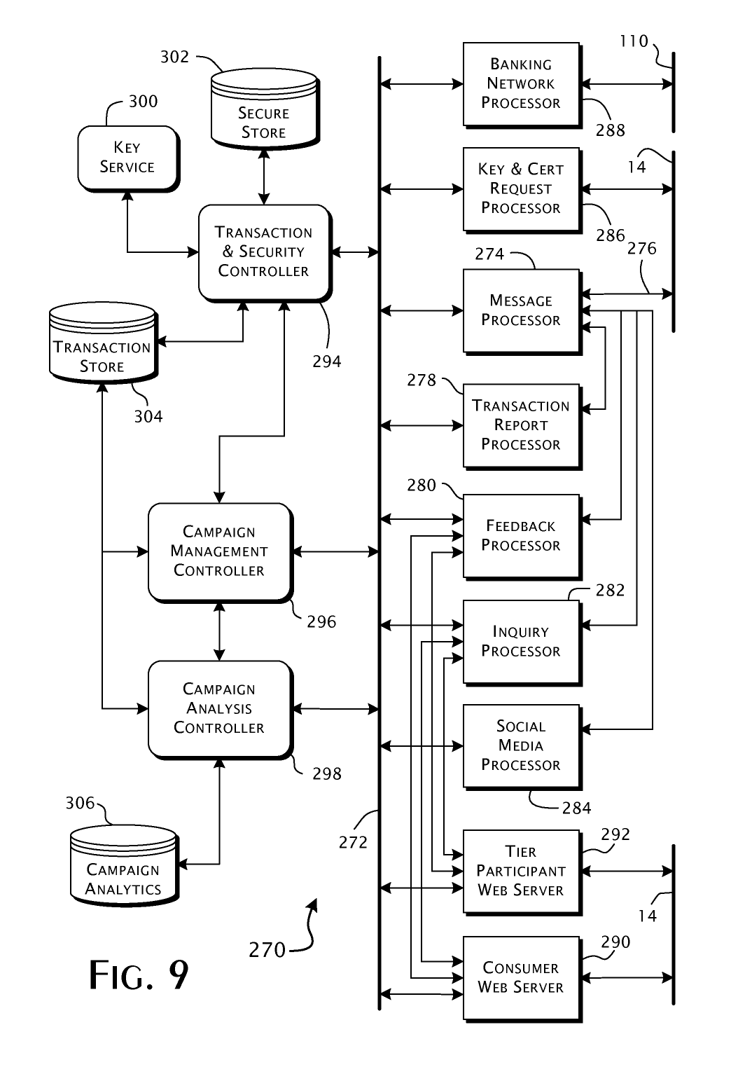

The coordinated transfer 480 of money and reward points in relation to the execution of an incentive campaign is further shown in FIG. 8. Initially, a producer 212, including any actively participating channel vendors 222, 224, establish 482 a campaign cash account with a suitable, preferably external financial institution. Notice of the establishment of the cash account is provided 484 to the incentive management system 140. In response, a producer points account 486 is established internal to the incentive management system 140.

Subsequently, a consumer 144 may perform an activity, such as publishing relevant content through a social media or other public service, that is recognized by the incentive management system as a qualifying activity with respect to the incentive campaign. In recognition, some corresponding number of reward points are transferred 488 from the producer points account 486 to a corresponding consumer points account 490 also established internal to the incentive management system 140.

Notably, this and most interactions involving the consumer 144 are such that the specific identity of the consumer 144 can be and preferably is withheld from the various business entities participating in an incentive campaign. While the producer 212 may be notified of the transfer out of reward points, the notice preferably only identifies the recipient by a unique reference number determined and maintained by the incentive management system 140 on behalf of the consumer 140. This anonymity feature can and, in general, preferably also is extended also to all tier X participants. Consumers 144 and tier X participants can opt-in to allowing the incentive management system identify them to an identified tier X participant that is party to a transaction of other communication transferred through the incentive management system 140.

In the preferred embodiments of the present invention, tier X participants 492 in the supply chain for products and services involved in an incentive campaign can also perform qualified activities as defined by the incentive campaign design. When recognized 494 by the incentive management system 140, either by explicit notice from the acting tier X participant or as may be independently noticed by the incentive management system 140, a corresponding number of reward points are transferred from the producer points account 486 to a vendor points account 496 established internal to the incentive management system 140.

A consumer 144 will typically purchase products or services from a retail tier participant who is one of the tier X participants 492. In making the purchase, money is transferred 498 from a consumer cash account 500 or paid directly in cash. This consumer cash account 500 is preferably established external to the incentive management system 140 with a suitable financial institution. The account 500 is preferably identified sufficiently to the incentive management system 140 relative to the consumer 144 to allow monetary transfers to be made electronically to the account. The account 500 may be further associated with the incentive management system 140 to enable use of the rewards card 122 issued to the consumer 144 to be used as a debit, or similar, card. The only information required to be provided by the consumer 144 at the point of sale is an account identifier, typically provided by presentation of the rewards card 122.

On subsequent reporting 502 of the transaction to the incentive management system 140, providing qualifying products or services were sold, a corresponding number of reward points are transferred for the producer points account 486 to the consumer points account 490. If provided for in the design of the incentive campaign, reward points are also transferred to the corresponding vendor points account 496. Preferably, the number of reward points transferred to a retail or other tier X participant 492 is computed on a categorical basis defined in relation to the position of the tier X participant 492 in the relevant supply chain.

A consumer 144 can, separately or in conjunction with any other transaction, redeem reward points by trade 504 based on a well-defined cash value. That is, the reward points are traded for products and services of a determined equivalent value. Such a trade occurs, for example, in the purchase for value of a gift card or other product or service. When notice 506 of the transaction is provided to the incentive management system, a corresponding number of reward points are transferred from the consumer points account 490 to the vendor points account 496.

Rather than for trade, a consumer may redeem 508 reward points directly for cash, paid out directly to the consumer or transferred to the consumer cash account 500. On notice to the incentive management system 510, a settlement order is issued to the financial institution handling the producer cash account 482. The identified recipient on the settlement order is a corresponding vendor cash account 512 where the redemption 508 was paid out as cash to the consumer 144. This vendor cash account 512 is preferably established external to the incentive management system 140 with a suitable financial institution. Sufficient information identifying the vendor cash account is provided to the incentive management system 140 to enable electronic funds transfer in a conventional manner. If instead the redemption value is to be credited to the consumer cash account 500, the settlement order identifies the consumer cash account sufficient for an electronic transfer to be processed in a conventional manner. While the settlement order information is generally sufficient to identify the consumer 144, preferably the identifying information is kept by the financial institution without disclosure to the producer 212. At the same time, the number of points redeemed by the consumer 144 is deducted 514 from the consumer points account 490.

Similar to a consumer 144, a tier X participant 492 can redeem points held in a corresponding vendor points account 496. On notice of the redemption 516, the corresponding cash value is transferred from the producer cash account 482 to the corresponding vendor cash account 512. The transfer is preferably made electronically in response to a settlement order issued by the incentive management system 140. The number of points redeemed by the tier X participant 492 is then deducted from the corresponding vendor points account 496.

At an appropriate termination point in the execution of the incentive campaign, a termination message is provided by the incentive management system 140 to the producer 212. Generally at the same time, any fees or other costs owed to the incentive management system 140 are transferred 518 from the producer cash account 482 to the incentive management system 140. Any remaining reward points in the producer points account 486 are deleted.

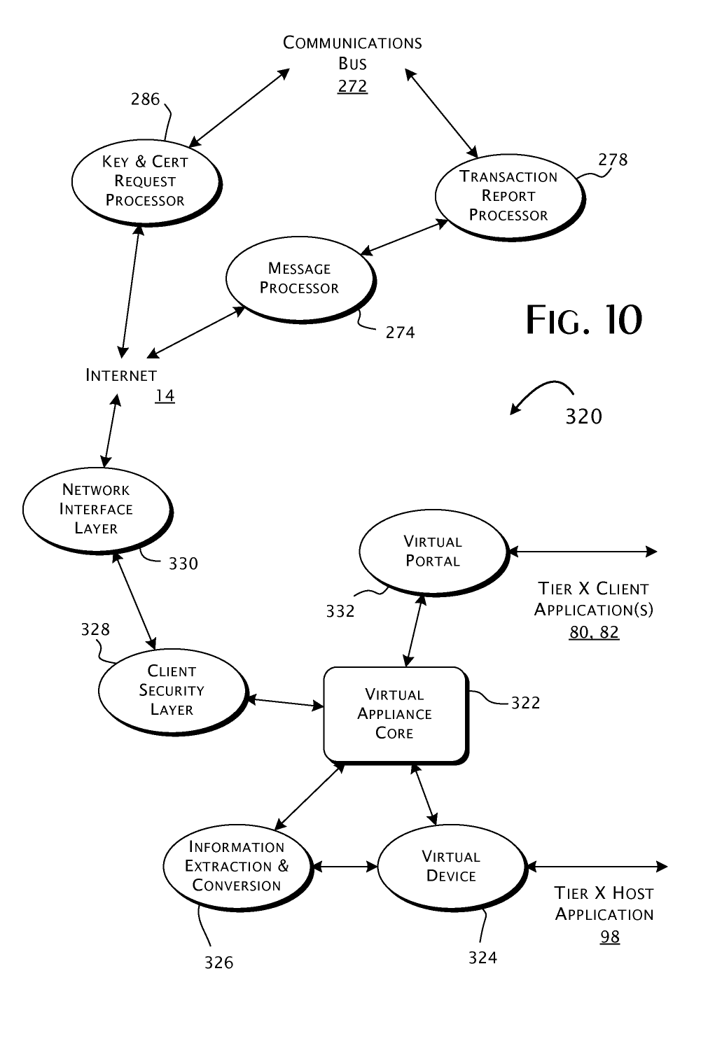

The present invention is preferably implemented utilizing an enterprise system architecture that readily enables distributed execution of the incentive management system 32 while ensuring secure communications between the various components of the system 32. The presently preferred enterprise software architecture 270 is generally illustrated in FIG. 9. The enterprise software architecture 270 preferably implements a secure communications bus 272 as a message transport facility for most communications that occur within the incentive management system 32. The secure communications bus 272 can be implemented using an event-based messaging router system typical of conventional message oriented middleware (MoM) enterprise frameworks or a conventional enterprise service bus (ESB) framework. Message oriented middleware frameworks often require less effort to create the initial or early versions of Web applications. Enterprise service bus-based Web applications realize significant management and performance benefits particularly at large scales.

A message processor 274 is preferably implemented to handle most communications with devices and systems external to the incentive management system 32. The message processor 274 is preferably coupled between the communications bus 272 and the Internet 14, via a network interface 276. The message processor 274 is preferably implemented with a generalized ability to communicate with various Internet based sites, services, and protocols including those established specifically to interact with the incentive management system 32. In addition to the standard packet transport layer Internet protocols, the message processor 274 preferably adds supports the Simple Mail Transport Protocol (SMTP), Internet Message Access Protocol (IMAP), Multipurpose Internet Mail Extensions (MIME) protocol, and other similar e-mail-based communications and content formatting protocols. Preferably, the message processor 274 supports the message form, addressing, and content conversion requirements necessary to both receive and transmit Short Message Service (SMS) protocol-based messages. SMS messages are preferably relayed through the Internet 14 between the message processor 274 and a suitable, external internetworking gateway service providing access to the Public Land Mobile Network (PLMN), for mobile devices, and the Public Switched Telephone Network (PSTN), for fixed station devices, as appropriate to reach addressed endpoints. Other protocols are supported to enable block data transfers, such as the File Transport Protocol (FTP), and various forms of streaming data transfers, using protocols such as the HTTP-based Asynchronous Javascript and XML (AJAX) protocol and those based on the recently standardized (2011) WebSocket protocol. API access to existing social media sites will typically require a high-bandwidth streaming or block data transfer connection to handle the substantial volumes of social media messages continually transiting these sites. Multiple, optionally distributed instances of the message processor 274 may be executed as needed to support the volume of communications transactions directed to or initiated by the incentive management system 32.

Multiple, specialized communications processors are preferably implemented as part of the incentive management system 32 to support and extend the protocol processing and data conversion operations of the message processor 274. In particular, a transaction report processor 278 is implemented to recognize the effective formatting specification of received transaction reports. The transaction report processor 278 preferably implements corresponding parsers that execute to extract transactional account identifiers and record-associated identifiers of the applicable products and services bought, sold, and exchanged. The native format of transaction reports will vary greatly due to the often proprietary transaction report generation functions implemented by the various tier X host applications 98. For the preferred embodiments of the present invention, virtual appliances 106 are preferably customized and deployed to tier X participant sites when (1) a tier X participant requires security assurances relative to the transport of their proprietary information over the Internet 14, (2) the configuration of a tier X host application 98 is such that collection of and processing of native transaction reports is best performed through a local virtual device, and (3) the necessary processing load to extract the requisite information from the native transaction reports can or is best scheduled and performed at the tier X participant site. As such, deployment of a virtual appliances 106 can significantly ameliorate the processing load on the transaction report processor 278 by performing appropriately tailored data conversions and extraction operations effectively local to the tier X host applications 98. As relevant transactional information is extracted by the transaction report processor 278, corresponding messages are transferred to the communications bus 272. Preferably, these messages will require little if any further processing by the transaction report processor 278.

A feedback processor 280 is preferably implemented to convert various forms of feedback data into messages that can be appropriately evaluated, in general, by the incentive management system 32. This evaluation may be performed to quantitatively or qualitatively assess the stated object of the feedback and to determine any applicable allocation of reward points to the account corresponding to the author of the feedback given. In addition, the evaluation may determine that a specific question or reported issue is to be reported to one or more business entities, as responsible tier participants in a reported transaction, for consideration and possible response. While this evaluation is performed by other elements of the incentive management system 32, the feedback processor 280 remains responsible for extracting the relevant information from the received feedback data.

Similarly, an inquiry processor 282 is implemented to handle received data and to extract sufficient information to enable further evaluation by the incentive management system 32. Inquiries are typically received from a variety of sources, though generally reflecting a similar request for information regarding a product or service that may qualify for a currently running incentive campaign. The inquiry data received will often include a barcode image scan, product link, or other description of the product or service in question. Images and, in turn, the barcodes must be deciphered, product links followed, and any provided descriptive information interpreted, if possible, to determine the product referenced and establish the relevant context of the inquiry. Preferably, a new message is generated by the inquiry processor 282 and placed on the communications bus 272 for further evaluation in response to each instance of inquiry data received.

A social media processor 284 is implemented to, in general, to handle multiple social media content feeds and other sources of public content that mentions products and services that are subject to a planned or presently running incentive campaign. In particular, directed references to relevant social media content can be generated through operation of the consumer specialized application, a form presented via the client Web browser application 182 allowing identification of, for example, a recently posted blog article, including a relevant comment made to a blog article, and the information stored in a corresponding account profile identifying relevant social media services and identities and other locations of content publication. These directed references may be forwarded to the social media processor 284 using any of a variety of protocols, including SMS, SMTP, SSL/TLS, and HTTP. The social media processor 284, in conjunction with the message processor 274, preferably implements the feed aggregator 192 to acquire, via feed-specific APIs and network protocols, multiple different social media data feeds. These feeds are processed through the recognizer 184 to decode and extract content with sufficient detail to enable identification of the product or service mentioned and the content author in a manner that can be referenced ultimately to an internal points account.

Further processing is preferably performed to establish the represented sentiment. In preferred embodiments of the present invention, the represented sentiment may be considered as a qualifier or weight applied to adjust the number of points awarded with respect to any particular social media content published. In addition, the business entity or consumer profile associated with an identified internal points account may be used as the basis to determine additional qualifiers and weights. As one example, the number of followers of a content author who will almost necessarily and immediately see newly posted content can be used as a positive weighting factor. In addition, demographic factors drawn from the social media profile of a content author and identifiable followers, such as age, geographic location, interests, and professions, can also be evaluated and applied as point award qualifiers and weights so as to tailor the allocation of reward points to the as-designed target demographic of any particular incentive campaign. This further processing may be implemented in the through execution of the social media processor 284 or performed at a higher architectural level within the incentive management system 32. In any event, new messages are transferred to the communications bus 272 for each adequately identified piece of newly published public content.

For the presently preferred embodiments of the present invention, a number of specific functions hosted or employed by the incentive management system 32 communicate directly with the Internet 14 or other networks 110. In particular, a secure key and certification processor 286 hosted by the incentive management system 32 for the benefit of registered business entities and consumers implements a very standard, lightweight service interface accessible from the Internet 14. Because the service interface is well defined and secure, public communications between the Internet 14 and secure key and certification processor 286 need not be routed through the message processor 274. Service requests handled by the secure key and certification processor 286 are represented by messages place on the communications bus 272 effectively requesting final message evaluation and generation of a corresponding response. The response is returned as a message received by the secure key and certification processor 286 and converted into a protocol appropriate response transmitted to the Internet 14.

Similarly, a banking network processor 288 may interface directly to a network 110 that is proprietary to or otherwise operated in a well secured manner by banking, financial, and other similar institutions. The banking network processor 288 is responsible for translations and data conversions for messages exchanged with the communications bus 272 and transport protocols and data formats necessary to securely communicate with financial institutions via the network 110.

The consumer Web site server 290 and tier participant Web site server 292 are also preferably implemented with Internet 14 access interfaces generally independent of the message processor 274. In the preferred embodiments of the present invention, certain functions implemented by the consumer and tier participant Web site servers 290, 292, are functionally supported by operation of other processors. In particular, contact forms and other forms allowing an identified user of the servers 290, 292 to request general or specific information regarding participating business entities, products and services are preferably processed through the inquiry processor 282. The form data may be routed directly to the inquiry processor 282, generally as shown, or passed as messages via the communications bus 272.

The consumer and tier participant Web site servers 290, 292 may also present forms that allow an identified user to provide feedback through, for example, a general purpose text input form or by completion of a survey. The collected feedback information is preferably processed through the feedback processor 280. As with the inquiry information, the collected feedback information may be passed directly to the feedback processor 280 or by way of the communications bus 272.

The higher architectural levels of the incentive management system 32 include a transaction and security controller 294, campaign management controller 296, and campaign analysis controller 298. The transaction and security controller 294 is responsible for handling security messages relative to the key and certification processor 286. In this capacity, the transaction and security controller 294 implements a set of security policies that encompasses all significant interactions with the incentive management system 32 via the Internet 14, banking network 110, or other manner of reaching a public interface of the incentive management system 32. In conjunction with a key service 300 and secure data store 302, the transaction and security controller 294 maintains the account login credentials for all business entities and consumer users of the incentive management system 32. For the preferred embodiments of the present invention, the transaction and security controller 294 also maintains a digital TLS server certificate, issued by an established, external Certificate Authority, for use in authenticating the incentive management system 32 to others. In addition, to be discussed in further detail below, the transaction and security controller 294 may issue short-term digital TLS client certificates to participating business entities and consumers.

The transaction and security controller 294 is also responsible for verifying and recording transactions received via the transaction report processor 278. As transaction records are received, the account identifiers are checked against business entity and consumer account records as stored by the secure data store 302. The associated products and services are checked against a list of such items correlated to the different currently executing incentive campaigns. Records of activities potentially qualified for allocation of reward points are similarly checked. Where validated, the transaction records are stored in a transaction store 304 and award points are transferred between internal points accounts, stored in the secure store 302, based on the design parameters of the associated incentive campaign.

The campaign management controller 296 is generally responsible for the processes involved in the design and execution of incentive campaigns. Relative to the design of incentive campaigns, the campaign management controller 296 interoperates with the tier participant Web server 292 to present a design interface, or dashboard user interface, that allows a business entity to review and select parameters defining an incentive campaign. These parameters generally include a start date, cash funding amount, duration, products and services included, reward point allocation formulas for products and services purchased, allocations for other activities performed by business entities and consumers, typically such social media publications by consumers 144 and advertising by other participant entities 148, and selection of demographic criteria and weighting factors, typically such as geographic region, purchase in combination with other products, and volume of products and services purchased. Preferably, other parameters may be defined provided the incentive management system 32 is able to collect or access the relevant basis information. To this end, the incentive management system 32 will ask for consumer social media identifications and sufficient privileges to access social media profiles.

In relation to the execution of incentive campaigns, the campaign management controller 296 generally operates in supervision of the transaction and security controller 294. The campaign management controller 296 is responsible for enabling the transaction and security controller 294 to begin processing transaction and activity records at the initiation of an incentive campaign. The campaign management controller 296 is also preferably responsible for triggering polling operations by the transaction report processor 278 to retrieve transaction reports. Where virtual appliances 106 have been deployed, the campaign management controller 296 preferably checks periodically on the health of each virtual appliance 106. In response to inquiry messages, the campaign management controller 296 preferably accesses the secure store 302 and the transaction store 304, through the transaction and security controller 294 as appropriate, in development of an appropriate response message. In addition, the campaign management controller 296 may access external databases, managed by the business entities, to retrieve information regarding the business entities and their products and services. The formulated response message is then sent, typically through the message processor 274, to the business entity or consumer that initiated the inquiry.

Feedback messages are handled by the campaign management controller 296 subject to the nature of the feedback being given by a business entity or consumer and the interests of the business entity addressed by the feedback. For spontaneous feedback or feedback that is general in nature, the campaign management controller 296 will preferably store a feedback record in the transaction store 304, allowing for an aggregate representation of the quality of a manufacturer, brand, product or service to be used typically in the design phase of other incentive campaigns. For feedback solicited by a business entity, such as by questionnaire and survey, the feedback information is preferably captured in detail in corresponding records stored into the transaction store 304. Detailed feedback reports can then be provided to the business entity generally on demand.

The campaign management controller 296 preferably also performs a general supervisory role in the management of the campaign analysis controller 298. In the presently preferred embodiments of the present invention, the campaign analysis controller implements, in general terms, a business informatics analysis function against the as-designed incentive campaign parameters and the corresponding campaign associated records as stored in the transaction store 304. At a minimum, a statistical analysis is performed to identify signifiant correlations between the as-designed incentive campaign parameters and purchases of the products and services that were the target of the incentive campaign. Preferably, the campaign analysis controller 298 also implements a machine learning system that, subject to supervision of the training data set selections, is optimized to identify patterns of the as-designed incentive campaign parameters that correlate to a targeted result, typically a maximization of sales of the target products and services to consumers 144. The business informatics data produced in the operation of the campaign analysis controller 298 is stored to a campaign analytics database for subsequent use and refinement.

A preferred implementation 320 of a virtual appliance 106 is shown in FIG. 10. A virtual appliance core 322 is preferably realized by a virtual machine image that can be executed on a conventional virtualization platform that is, in turn, hosted and executed by a conventional server computer system. Suitable virtualization platforms include Oracle VM VirtualBox (Oracle Corp.), the Xen hypervisor (Xen Project), and VMware ESX/ESXi (VMware, Inc.). The virtual machine image preferably includes a relatively minimal instance of a network-capable operating system. Dependent on the specific implementation and capabilities of a tier X host application 98, a device driver application is integrated with the virtual machine image to present a virtual device 324 recognizable to the tier X host application 98. That is, the virtual device 324 effectively implements a device known and supported by the tier X host application 98 that, from the perspective of the tier X host application 98, may be either a software or hardware device. The virtual device 324 preferably implements a defined API or other software interface that the tier X host application 98 expects to use to communicate with this known device. Where this communications interface is realized directly in hardware, an emulation of the hardware interface is preferably implemented using a software trap service. A characteristic example of a known device is a printer, where the tier X host application 98 can be readily configured to print reports containing the transaction information intended for the incentive management system 32. The print data stream is directed a known printer driver interface that is instead implemented by the virtual device 324.

The data stream provided to the virtual device 324 is preferably routed to an executable module 326 for parsing and extraction of account identifiers and related product and service purchase information. This extraction process 326 is tailored to both the format of the transaction records provided in the data stream and the particular target hardware device command set directed to the virtual device 324. Data conversions, such as European to US number format and short to long date formatting, are also applied as appropriate. The resulting transaction record information is preferably composed into a message suitable for consumption by the incentive management system 32.

Transfer of extracted and converted transaction record messages involves a client network security layer 328 and a network interface layer 330 as typically implemented in the virtual appliance core 322. In preferred embodiments of the present invention, the client security layer 328 is utilized to apply an additional layer of encryption to the information contained in transaction record messages. The selection of this additional layer of encryption, and the encryption keys to be used, are initially obtained from the key and certification processor 286 through a series of secure message exchanges made via the Internet 14. In a preferred embodiment of the present invention, this additional layer of encryption is realized through establishment of a secure sockets layer (SSL) communications connection. In another preferred embodiment of the present invention, all or part of each transaction record message is encrypted using a secondary encryption key obtained from an additional digital certificate provided by the key and certification processor 286. This additional digital certificate is preferably allocated on a per-incentive campaign basis, thereby restricting deciphering to at most the subset of business entities that are actively participating in the corresponding incentive campaign.

The network interface layer 330 preferably transmits each transaction record message, via the Internet 14, to the message processor 274. A block or streaming network protocol can be used based on a preset parameter in the virtual appliance core 322. Alternately, the network interface layer 330 and message processor 274 can negotiate selection of a transfer protocol based on, for example, the current load factor of message processor 274, the buffered size of transaction record messages pending transport, and the implicit capabilities of the specific instance of the virtual appliance core 322. Once transferred, these transaction record messages require minimal further processing by the transaction report processor 278.

In addition to the virtual device 324, the virtual appliance core 322 may also incorporate a virtual portal application 332 that enables additional layers of security to be applied to some or all communications between a tier X participant site and the incentive management system 32. The virtual portal application 332 may implement a proxy interface for HTTP-based communications or a dedicated network channel. Where the local tier X host application 98 has or can be readily modified to provide a customized transaction record feed tailored for consumption by the incentive management system 32, the feed can be directed through the virtual portal 332, thereby avoiding the overhead processing requirements of the virtual device 324. The customized transaction record feed thus gains the benefits of the additional security afforded by the client security layer 328.

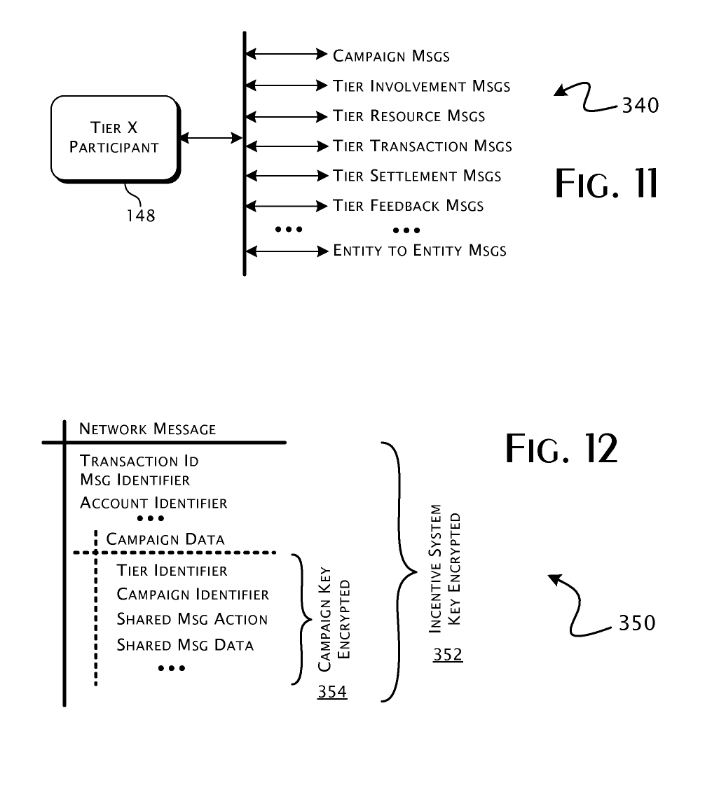

A general representation 340 of the messages that can be exchanged between the incentive management system 32 and a tier X participant 148 is shown in FIG. 11. The various messages types allow the tier X participants to engage in all aspects of the operation of the incentive management system 32. In particular, these message types also include business entity to business entity messages that are, in effect, routed through the incentive management system 32. During the development of a new incentive campaign and while the campaign is underway, messages can be exchanged in discussion of different aspects of a proposed or executing incentive campaign. In an alternate embodiment of the present invention, two or more business entities can request issuance of an appropriately shared digital certificate the will securely constrain the reading of these entity to entity messages to a well-defined group of business entities.

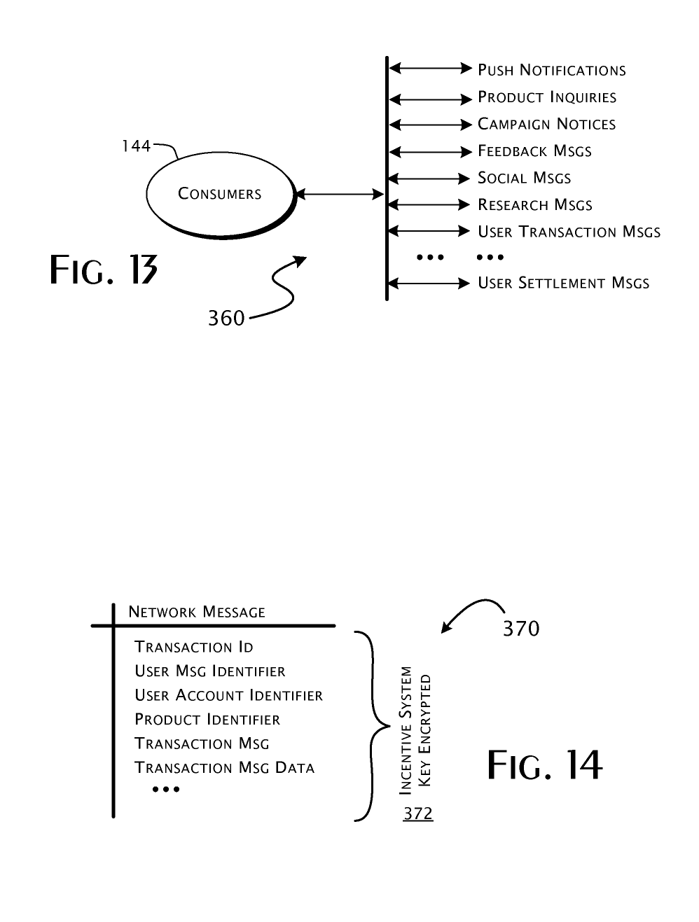

A representative network message 350 implementing an additional level of encryption is shown in FIG. 12. A first level of encryption 352, corresponding to a digital certificate issued generally to all business entities participating in the incentive management system 32, is used to encrypt the body of a network message. A second level of encryption 354 is prior applied to at least the substantive portion of the network message concerning details of an incentive campaign in a planning stage or that is currently running. Notably, this second level of encryption 354 may not be applicable to network messages inbound to the message processor 274. The various protocols that may be used to send an inbound network message likely do not readily support implementation of the second level encryption. Network messages effectively generated through use of the tier participant Web site 292 are transferred to the message processor 274 internal to the incentive management system 32. Network messages sent inbound through the virtual appliance 106 can be readily protected with the second level encryption. For outbound messages, the constraints on using the second level encryption are, in effect, the same.

A general representation 360 of the messages that can be exchanged between the incentive management system 32 and the consumers 144 is shown in FIG. 13. The set of messages exchanged by consumers 144 reflect the difference between the production, distribution, and retail tiers, as one class of users of then incentive management system 32 and the consumers 144. Specifically, many of the consumer messages are generated through the performance of incentivized activities that will influence and induce other consumers to consider purchasing the products and services targeted by an incentive campaign. That is, the preferred embodiments of the present invention operate to incentivize not just direct purchases of targeted products and services, but to also actively incentivize discussion of those products and services with the goal of altering the perception of the targeted products and services at the point of consumer selection for purchase.

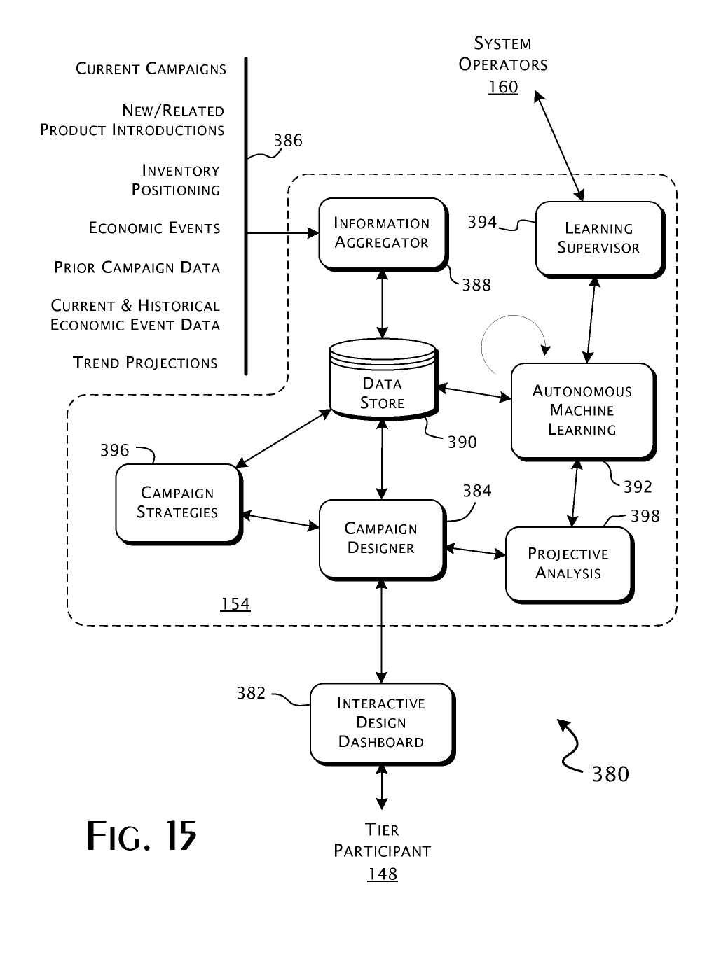

Referring to FIG. 14, a consumer directed network message 370 is shown. As a reflection of the differences between the consumer tier and the business oriented tiers, the network message 370 is preferably secured with a single level of content encryption 372. Preferably, the applied encryption 362 is compatible with the various protocols that may be used in the transmission of the network message 370 to or from a consumer 144.

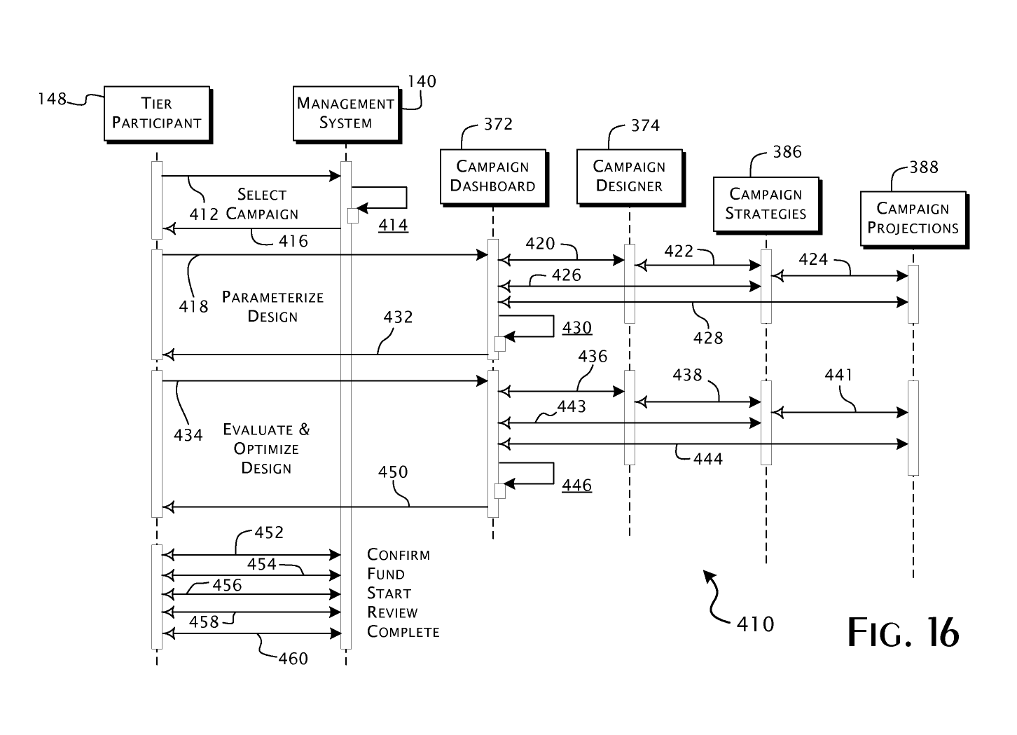

A preferred implementation of the incentive campaign creation component 154 is shown generally in FIG. 15 as the design element 380 used for interactive creation and evaluation of incentive campaigns. In the preferred embodiments, the tier participant Web server 292 is used to host an interactive design dashboard Web application 382 accessible to tier participants 148. The design dashboard 382 communicates with a campaign designer subcomponent 384 that organizes the internal operation of the campaign creation component 154. A variety of data feeds 386, generally as drawn through the monitoring component 150, provides content that is variously organized, summarized and categorized by operation of an information aggregator 388.

In a preferred embodiment of the present invention, the information aggregator 388 is implemented as a key element recognizer that is sensitive to date, time, value and a set of predefined keywords and phrases. In alternate embodiments of the present invention, the information aggregator is implemented using a data-extraction and analysis system subject to supervised training, such as one based on machine learning and/or data extraction ontologies. In either case, a primary aspect of the data feeds considered is the historical performance of prior campaigns and the corresponding campaign design parameters. Current incentive campaigns are considered for both positive and negative effects. Current campaigns can provide the most relevant information on the interests and activities of consumers. Conversely, current campaigns that are targeting competitive, or near-competitive products and services can reduce the significance of offered incentives in a concurrent incentive campaign. Similarly, recent competitive and near-competitive product introductions can help or hinder a new incentive campaign. Another potentially significant factor is the current or anticipated positioning of inventory in the target or related supply chains. An excess of relevant inventory may induce the corresponding distributor business entities to more actively participate in an incentive campaign, either through allocation of greater advertising resources or direct contribution to the monetary cash account established for incentive points redemption. Economic events, such as holiday schedules and releases of various economic reports and forecasts, are preferably also identified from the data feeds 386.

Information processed from the information aggregator 388 is collected and stored in a local data store 390. In the preferred embodiments of the present invention, an autonomous machine learning subcomponent 392 runs as a background task to process new data as stored to the data store 390. The learning subcomponent 392 preferably implements any of several different types of machine learning systems, including rule-based, statistical, Gaussian regression, and multidimensional partitioning and clustering classifiers. In general, a supervised learning system is preferred, though use of inferencing in support of, for example, unsupervised learning relative to unlabeled data, is also desirable. A learning supervisor component 394 is provided to allow system operators 160 to monitor and direct the learning operation implemented by the learning subcomponent 392.

A campaign strategies subcomponent 396 is preferably provided to substantively assist in the creation of incentive campaigns. Preferably, the campaign strategies subcomponent 396 is implemented primarily as a set of pre-evaluated design templates that can be selected based on categorical tags relevant to the primary factors presumed significant in each design template. The initial values of various applicable design parameters are preset in the templates. These values, however, can be altered or removed depending on the choices made and applied through the design dashboard 382.

Once an initial design has been selected, or when a prior existing design is selected for further consideration, the set of incentive campaign design parameters can be submitted for projective analysis 398. Based on the learned data state, projective analysis 398 will execute to determine the most likely outcomes of various aspects of the designed incentive campaign. Based on the projected outcomes, the tier participant 148 is free to adjust the design parameters and resubmit for projective analysis 398. This interactive design of an incentive campaign can continue until the tier participant is satisfied with the design. The incentive campaign design can then be scheduled for implementation through the incentive management system 32.

The preferred incentive campaign design process 410 is further illustrated in FIG. 16. Initially, a tier participant 148 interacts 412, through the dashboard 382, with the management system 140 to review available incentive campaign designs 414. These designs include templated designs 396, previously developed and potentially used designs, designs of incentive programs that have been announced, but not yet started, and currently executing incentive campaign designs. Any of these designs may be selected 416.

Once selected, a design is made available 418 for modification in the campaign dashboard 382. Modification of pending and executing designs may be limited based on business rules established by the system operators 160. Modification of copies of these designs may be freely made. Preferably, when design parameters are modified 420, the prior designs and existing campaign strategy templates are autonomously reviewed 422 for closest matches as a basis for presenting recommended parameter ranges to the tier participant 148 via the campaign dashboard 372. In addition, for purposes of time efficiency, a campaign projection operation may be initiated 424 as a background task. The tier participant can make parameter modifications 426 as desired and submit the design for projective analysis 388. The design can then be considered 430, in light of the projected outcomes, by the tier participant 148. The design can be accepted 432 or the tier participant 148 can make further parameter modifications.

When accepted, the incentive campaign design may be publicized to other tier participants 148 to obtain commitments for active participation. In response to the publication, the other tier participants 148 are able to select 414 the proposed campaign design and proceed to evaluate 430 the impact of different levels of active participation by the tier participant. The initiating tier participant and other tier participants are then able to discuss among themselves various modifications to the incentive campaign design and the willingness to participate at different levels.

In this negotiation stage, the involved tier participants can set 434 a copy of the proposed campaign design in the campaign dashboard 372 and adjust the design parameters to reflect the proposed levels of participation of all of the involved tier participants. When appropriately considered 446 and finally accepted 450, the initiating tier participant will interact with the incentive campaign management system 140 to progress implementation through the stages of confirming the design selection 452, funding the rewards cash account according to the design 454, and formally initiating the execution of the campaign 456. The involved tier participants can review the progress of the campaign 458 at any time during the execution of the campaign. Finally, the initiating tier participant 148 will confirm the end of the incentive campaign and the campaign design will be marked complete.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer system implementing an incentive rewards allocation program among vertically positioned entities operating for the delivery of a defined product to a consumer, said computer system comprising:
a) a server computer system operative to implement a designed instance of an incentive awards program establishing a specification of defined point grants to be issued to reward accounts in response to defined activities performed in furtherance of said designed instance; and
b) a client computer system, coupled through a communications network to said server computer system, wherein said client computer system is operated with respect to a retail tier of a plurality of tiers of a defined supply chain, wherein said retail tier is above a consumer tier within said plurality of tiers, wherein said client computer system includes an input device operative to receive a system code defined in accordance with an established industry standard, said system code defined as including a manufacturer code identifying by preestablished values one of a plurality of industry manufacturers and a product category code identifying one of a plurality of categories of products manufactured by said one of said industry manufacturers, wherein said consumer tier includes said consumer, wherein said consumer provides a non-conformant system code to said input device to enable capture of an account identifier code embedded in said non-conformant system code, wherein said account identifier is associated with one of said defined activities.
